(19) United States
(12) Patent Application Publication
(10) Pub. No.: US 2016/0280124 A1
(43) Pub. Date: Sep. 29, 2016

(54) Tonneau Turtle

(71) Applicant: Jeffrey Prince, Tempe, AZ (US)

(72) Inventor: Jeffrey Prince, Tempe, AZ (US)

(21) Appl. No.: 15/078,728

(22) Filed: Mar. 23, 2016

Related U.S. Application Data
(60) Provisional application No. 62/136,730, filed on Mar. 23, 2015.

(51) Int. Cl. B60P 7/02; B60P 7/08

(52) U.S. Cl. CPC B60P 7/02; B60P 7/08

(57) ABSTRACT

The current invention is a tonneau cover that provide a barrier that covers the bed of a truck in order to conceal cargo. These covers are often soft, which can be easily broken into. The present invention offers a device that provides additional rigid protection for soft tonneau covers, thereby increasing the security of a truck bed. Additionally, use of the present invention can improve durability of existing covers as well as limit the wear and tear of the cover. This invention could also feature a system of hinges for ease of use. Further, the present invention can be offered in different colors in order to match the color of any vehicle for an enhanced appearance.

### PRIORITY

This applications claims priority from the disclosure of U.S. Provisional Patent Application Ser. No. 62/136,730 filed on Mar. 23, 2015, which is incorporated by reference herein.

### CROSS-REFERENCES TO RELATED APPLICATIONS (IF ANY)

None

### BACKGROUND

1. Field of the Invention

The present invention relates to Color Matched Tonneau Covers.

2. Description of Prior Art

Many truck and utility vehicle owners purchase tonneau covers for their vehicle. Unfortunately, such covers are made from a soft vinyl material, which can fade and rip, does not match the color of the vehicle, and can be easily compromised by thieves. With the durability and ruggedness of a truck, a tonneau cover should provide the same. Therefore, there is a need for a device that can provide additional protection to existing, soft tonneau covers.

Devices are known that relate to rigid tonneau covers. Some devices provide multilayer tonneau covers comprising a rigid upper layer that protects the lower layers. Other devices provide a three-layer tonneau cover comprising an outer layer composed of light, high-strength material. These devices, however, fail to provide a rigid supplemental cover that is removably attachable to the exterior surface of a tonneau cover. Further, these devices fail to provide for attachment to a tonneau cover in order to protect the soft tonneau cover from damage.

There is still room for improvement in the art.

### SUMMARY OF THE INVENTION

The current invention is a tonneau cover that provide a barrier that covers the bed of a truck in order to conceal cargo. It is a rigid tonneau cover.

The present invention is a device that provides additional rigid protection for soft tonneau covers which increases the security of a truck bed but the device is not just for soft Tonneau covers as it can also work with metal tonneau covers. Additionally, use of the present invention can improve durability of existing covers as well as limit the wear and tear of the cover. This invention could also feature a system of hinges for ease of use. Further, the present invention can be offered in different colors in order to match the color of any vehicle for an enhanced appearance.

The current invention is more efficient, effective, accurate and functional than the current art.

### BRIEF DESCRIPTION OF THE DRAWINGS

Without restricting the full scope of this invention, the preferred form of this invention is illustrated in the following drawings:

FIG. 1 displays a view of how the panels fit over the tonneau cover;

FIG. 2 displays a close-up view of how the panels screw into place;

FIG. 3 displays a close-up view of the panels secured to the truck;

FIG. 4 displays a view of the present invention in place on the bed of a truck;

FIG. 5 displays a view of the present invention secured on a utility vehicle; and

FIG. 6 displays a view of the present invention with a hinge.

### DESCRIPTION OF THE PREFERRED EMBODIMENT

There are a number of significant design features and improvements incorporated within the invention.

The present invention is a rigid color Matched tonneau cover or covers. The device 1, provides a rigid supplemental cover that is removably attachable to the exterior surface of a tonneau cover 20.

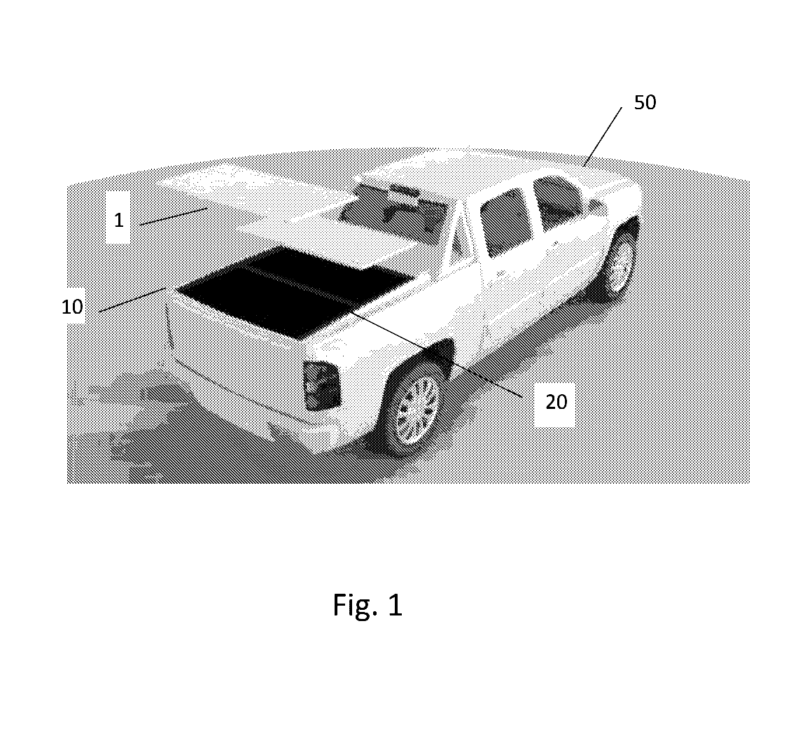

Referring now to FIG. 1, there is displayed a view of the present invention and how the panels 1 fit over the tonneau cover. The present invention provides a device 1 that protects a truck's 50 soft vinyl tonneau cover 20, thereby offering a more rugged, durable, and tamper-proof solution. The present invention can be secured over an existing soft vinyl tonneau cover 20 for convenience and is offered in sections in order to enable attachment to the tri-fold tonneau cover for convenience. The panels 1 are normally rectangular in shape and are the correct size to properly cover the bed of the truck 50 and tonneau cover 20. Multiple panels 1 can be used. This allows for ease of placement and movement while offering the most protection.

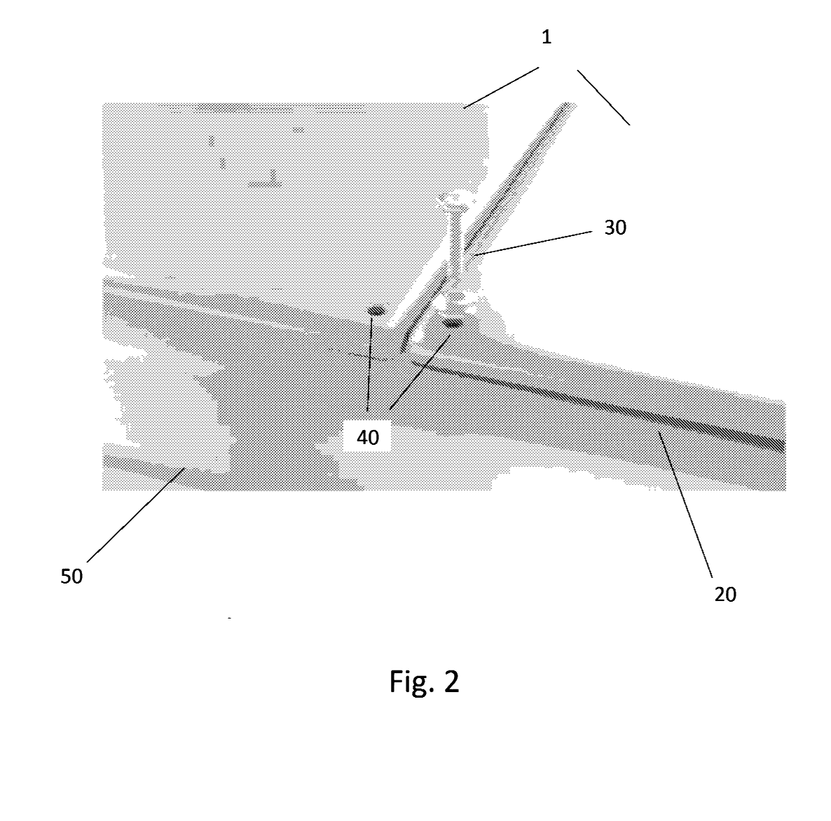

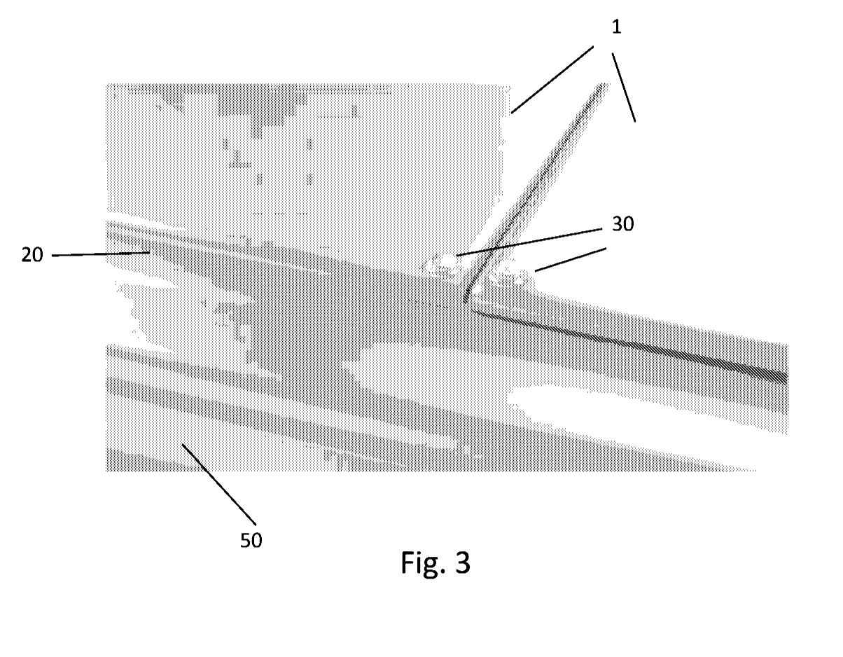

Referring now to FIGS. 2 and 3, there are displayed views of how the present invention is secured in place. The present invention provides a device 1 that offers superior protection to existing tonneau covers 20. The present invention comprises a series of rigid panels 1, made from metal sheathing or any other suitable material that cover and protect the tonneau covers 20. The panels 1 can be attached to a vehicle's 50 tri-fold tonneau cover 20. There are multiple ways to connect the device 1 to tonneau covers 20 using any number of different types of fasteners such as a simple set of nuts and bolts 30 set into fixed holes 40 and/or by use of adhesive material such as epoxy, gel, or adhesive tape. The panels 1, therefore, can be easily added or removed as needed.

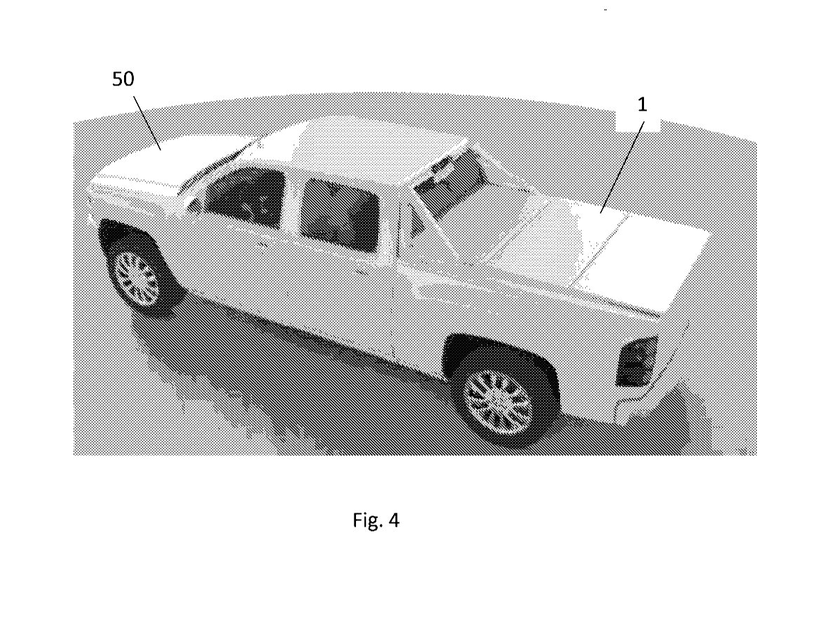

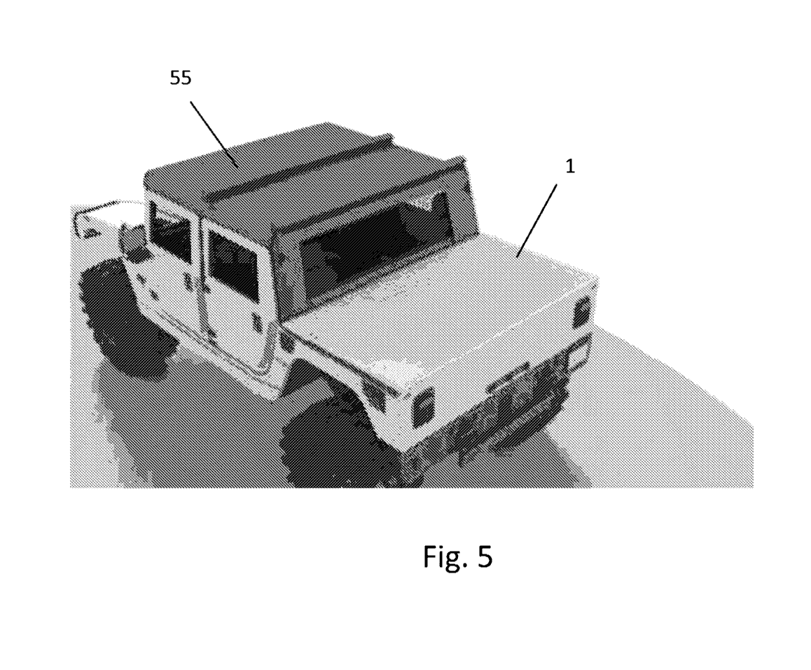

Referring now to FIGS. 4 and 5, there are displayed views of the present invention in use. The panels 1 of the present invention can be offered in various widths and sizes in order to accommodate most trucks 50 and utility vehicles 55. One panel 1 or a multiple number of panels 1 can be used depending on the vehicle and needs of the user. The present invention, therefore, provides convenient use on vehicles 50 such as the Chevrolet Avalanche, Cadillac EXT, and Hummer H2 SUT, or any other truck that offers an aftermarket tonneau cover 20. Further, the panels 1 an be designed to match the factory's paint colors. The exact specifications, however, may vary upon manufacturing.

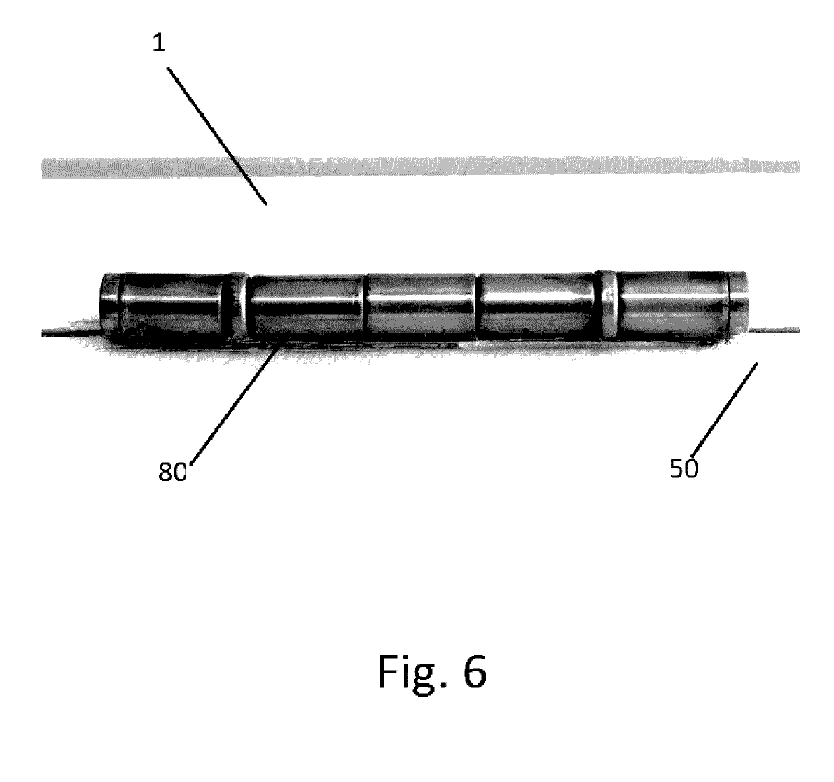

The panels 1 can also be connected to the tonneau cover 20 using hinges 80 as shown in FIG. 6. This allows for easy access to the bed. The panels 1 can still be removable if connected by hinges 80.

Even though the device 1 works well with soft Tonneau covers it is not just for soft Tonneau covers but can also work with metal tonneau covers

Although the present invention has been described in considerable detail with reference to certain preferred versions thereof, other versions are possible. Therefore, the point and scope of the appended claims should not be limited to the description of the preferred versions contained herein.

As to a further discussion of the manner of usage and operation of the present invention, the same should be apparent from the above description. Accordingly, no further discussion relating to the manner of usage and operation will be provided. With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

That which is claimed is:

1. A device to cover tonneau cover of a vehicle comprising:
a plurality of rigid panels.

2. A device according to claim 1 further comprising having the panels have a rectangular shape.

3. A device according to claim 1 further comprising having the panels having dimensions to properly cover the tonneau cover.

4. A device according to claim 1 further comprising having the panels colored to match the color of the vehicle.

5. A device according to claim 1 further comprising having the panels connected to the tonneau cover through a connection means.

6. A device according to claim 5 further comprising having the connection mean being a plurality of bolts.

7. A device according to claim 5 further comprising having the connection mean being a adhesive.

8. A device according to claim 5 further comprising having the connection mean being a plurality of hinges.

9. A device according to claim 5 further comprising having the connection mean being a adhesive tape.

10. A device according to claim 5 further comprising having the connection mean being a epoxy.

11. A process to cover tonneau cover of a vehicle comprising:
a plurality of rigid panels.

12. A process according to claim 11 further comprising having the panels have a rectangular shape.

13. A process according to claim 11 further comprising having the panels having dimensions to properly cover the tonneau cover.

14. A process according to claim 11 further comprising having the panels colored to match the color of the vehicle.

15. A process according to claim 11 further comprising having the panels connected to the tonneau cover through a connection means.

16. A process according to claim 15 further comprising having the connection mean being a plurality of bolts.

17. A process according to claim 5 further comprising having the connection mean being a adhesive.

18. A process according to claim 15 further comprising having the connection mean being a plurality of hinges.

19. A process according to claim 15 further comprising having the connection mean being a adhesive tape.

20. A process according to claim 15 further comprising having the connection mean being a epoxy.
